(19) United States
(12) Patent Application Publication
(10) Pub. No.: US 2023/0395278 A1
(43) Pub. Date: Dec. 7, 2023

(54) SLIT COPPER MATERIAL, COMPONENT FOR ELECTRONIC/ELECTRIC DEVICES, BUS BAR, AND HEAT DISSIPATION SUBSTRATE

(71) Applicant: MITSUBISHI MATERIALS CORPORATION, Tokyo (JP)

(72) Inventors: Hirotaka MATSUNAGA, Kitamoto-shi (JP); Kosei FUKUOKA, Kitamoto-shi (JP); Kazunari MAKI, Kitamoto-shi (JP)

(73) Assignee: MITSUBISHI MATERIALS CORPORATION, Tokyo (JP)

(21) Appl. No.: 18/245,097

(22) PCT Filed: Oct. 20, 2021
(86) PCT No.: PCT/JP2021/038742

§ 371 Date: Mar. 13, 2023

(30) Foreign Application Priority Data
Oct. 23, 2020 (JP) 2020-178072
Oct. 19, 2021 (JP) 2021-170964

(51) Int. Cl. H01B 1/02; C22F 1/08; C22F 1/02

(52) U.S. Cl. CPC H01B 1/026; C22F 1/08; C22F 1/02

(57) ABSTRACT

In this slit copper material, a purity of Cu is 99.96% by mass or greater, a ratio W/t of a plate width W to a plate thickness t is 10 or greater, an electrical conductivity is 97.0% IACS or greater, and an average value of orientation densities at φ2=5°, in a range of φ1=0° to 90°, and at Φ=0° in a plate center portion is 2.0 or greater and less than 30.0.

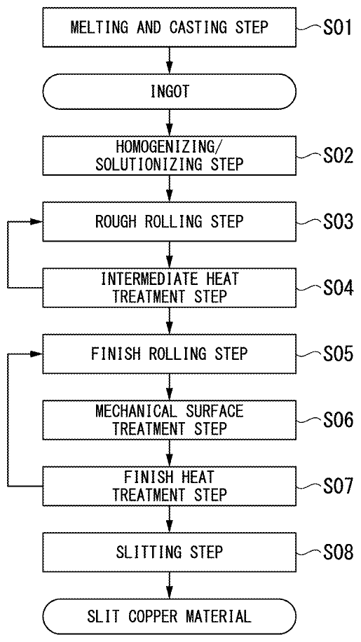

### CROSS-REFERENCE TO RELATED PATENT APPLICATIONS

This application is a U.S. National Phase Application under 35 U.S.C. § 371 of International Patent Application No. PCT/JP2021/038742 filed on Oct. 20, 2021 and claims the benefit of priority to Japanese Patent Applications No. 2020-178072 filed on Oct. 23, 2020 and No. 2021-170964 filed on Oct. 19, 2021, the contents of all of which are incorporated herein by reference in their entireties. The International Application was published in Japanese on Apr. 28, 2022 as International Publication No. WO/2022/085718 under PCT Article 21(2).

### FIELD OF THE INVENTION

The present invention relates to a slit copper material suitable for a component for electronic/electrical devices, such as a bus bar or a heat dissipation substrate, a component for electronic/electrical devices, a bus bar, and a heat dissipation substrate, which are formed of this slit copper material.

### BACKGROUND OF THE INVENTION

In the related art, copper or a copper alloy with excellent electrical conductivity has been used in a component for electronic/electrical devices such as a bus bar or a heat dissipation substrate.

With an increase in current of electronic devices and electrical devices, in order to reduce the current density and diffuse heat due to Joule heat generation, a pure copper material such as oxygen-free copper with excellent electrical conductivity is used for a component for electronic/electrical devices used for such electronic devices and electrical devices.

However, the pure copper material of the related art has a problem in that bending workability necessary for forming electronic devices, electrical devices, and the like is insufficient and cracking occurs particularly in a case where severe working such as edgewise bending is carried out.

Therefore, Japanese Unexamined Patent Application, First Publication No. 2013-004444 discloses an insulated rectangular copper wire including a rectangular copper wire formed of oxygen-free copper with a 0.2% proof stress of 150 MPa or less.

In the rolled copper plate described in Japanese Unexamined Patent Application, First Publication No. 2013-004444, since the 0.2% proof stress is limited to 150 MPa or less, degradation of voltage endurance characteristics in a bent portion in a case where the edgewise bending has been performed can be prevented.

Meanwhile, recently, a copper material used for the component for electronic/electrical devices is required to further improve the electrical conductivity so that the copper material can be used for applications where the pure copper material has been used, in order to sufficiently prevent heat generation in a case where a high current flows.

Further, recently, since more complex bending is performed in some cases, the above-described component for electronic/electrical devices is required to improve the bending workability more than before.

### PRIOR ART DOCUMENTS

### Patent Document

Patent Document 1: Japanese Unexamined Patent Application, First Publication No. 2013-004444

### Problems to be Solved by the Invention

The present invention has been made in view of the above-described circumstances, and an objective thereof is to provide a slit copper material having high electrical conductivity and excellent bending workability, and a component for electronic/electrical devices, a bus bar, and a heat dissipation substrate, which are formed of this slit copper material.

### SUMMARY OF THE INVENTION

### Solutions for Solving the Problems

As a result of intensive research conducted by the present inventors in order to achieve the above-described objective, it was found that a slit copper material is required to appropriately control the crystal texture so as to further improve the bending workability. That is, it was found that the bending workability can be further improved more than before by appropriately controlling an average value of orientation densities at φ2=5°, in a range of φ1=0° to 90°, and at Φ=0° when a crystal orientation distribution function obtained from texture analysis by the EBSD method is expressed in terms of an Euler angle.

The present invention has been made based on the above-described findings. According to an aspect of the present invention, there is provided a slit copper material, in which a purity of Cu is 99.96% by mass or greater, a ratio W/t of a plate width W to a plate thickness t is 10 or greater, an electrical conductivity is 97.0% IACS or greater, and an average value of orientation densities at φ2=5°, in a range of φ1=0° to 90°, and at Φ=0° in a plate center portion is 2.0 or greater and less than 30.0.

Further, the slit copper material is a material obtained by slitting a copper plate strip material such that the copper plate strip material has a predetermined width.

In the present specification, the plate center portion is defined as a region of 25% to 75% of the total thickness from the surface in the plate thickness direction.

According to the slit copper material with the above-described configuration, since the purity of Cu is 99.96% by mass or greater, the electrical conductivity can be ensured, and the electrical conductivity can be set to 97.0% IACS or greater.

In addition, since the average value of orientation densities at φ2=5°, in a range of φ1=0° to 90°, and at Φ=0° in the plate center portion is set to 2.0 or greater and less than 30.0, the bending workability can be sufficiently improved.

In the slit copper material according to the aspect of the present invention, it is preferable that an average crystal grain size A in the plate center portion is 50 μm or less.

In this case, since the average crystal grain size A in the plate center portion is set to 50 μm or less, the bending workability can be further improved. Further, formation of burrs in a case of slitting can be suppressed, and occurrence of cracking originating from burrs in a case of bending can be suppressed.

Further, in the slit copper material according to the aspect of the present invention, it is preferable that a ratio B/A of an average crystal grain size B in a plate surface layer portion to the average crystal grain size A in the plate center portion is in a range of 0.80 or greater and 1.20 or less.

In this case, since the ratio B/A of the average crystal grain size B in the plate surface layer portion to the average crystal grain size A in the plate center portion is set to be in a range of 0.80 or greater and 1.20 or less, localized concentration of the stress during working can be suppressed, and the bending workability can be further improved.

Further, in the present specification, the plate surface layer portion is defined as a region of 0% to 20% of the total thickness from the surface in the plate thickness direction.

Further, in the slit copper material according to the aspect of the present invention, it is preferable that a 0.2% proof stress in a direction parallel to a rolling direction is less than 150 MPa.

In this case, since the 0.2% proof stress in a direction parallel to the rolling direction is suppressed to less than 150 MPa, the bending workability can be further improved.

Further, in the slit copper material according to the aspect of the present invention, it is preferable that an average value of orientation densities at φ2=40°, in a range of φ1=0° to 15°, and in a range of Φ=0° to 15° in the plate center portion is less than 10.0.

In this case, the rolled texture is reduced, and the bending workability can be further improved.

Further, in the slit copper material according to the aspect of the present invention, the slit copper material may have a thickness of 0.1 mm or greater and 10 mm or less.

In this case, since the thickness is in a range of 0.1 mm or greater and 10 mm or less, a component for electronic/electrical devices, such as a bus bar or a heat dissipation substrate, can be formed by subjecting the slit copper material to punching or bending.

Further, in the slit copper material according to the aspect of the present invention, it is preferable that the slit copper material includes a metal plating layer on a surface.

In this case, it can also be said that the slit copper material includes a slit copper material main body and a metal plating layer provided on the surface of the slit copper material main body. The slit copper material main body has the same characteristics as those of the slit copper material according to the aspect of the present invention described above. The slit copper material includes the metal plating layer on the surface, and thus is particularly suitable as a material of a component for electronic/electrical devices, such as a bus bar or a heat dissipation substrate.

In addition, examples of the metal plating layer include Sn plating, Ag plating, and Ni plating. Further, according to the aspect of the present invention, the concept of “Sn plating” includes pure Sn plating or Sn alloy plating, the concept of “Ag plating” includes pure Ag plating or Ag alloy plating, and the concept of “Ni plating” includes pure Ni plating or Ni alloy plating.

A component for electronic/electrical devices according to an aspect of the present invention is formed of the slit copper material described above. Further, examples of the component for electronic/electrical devices according to the aspect of the present invention include a bus bar and a heat dissipation substrate.

Since the component for electronic/electrical devices with the above-described configuration is produced by using the slit copper material having excellent bending workability as described above, complex bending can be performed, and the size of the component can be reduced.

A bus bar according to an aspect of the present invention includes the slit copper material described above.

Since the bus bar with the above-described configuration is produced by using the slit copper material having excellent bending workability as described above, complex bending can be performed and the size of the bus bar can be reduced.

A heat dissipation substrate according to an aspect of the present invention is formed of the slit copper material described above.

Since the heat dissipation substrate with the above-described configuration is produced by using the slit copper material having excellent bending workability as described above, complex bending can be performed and the size of the heat dissipation substrate can be reduced.

### Effects of Invention

According to the aspect of the present invention, it is possible to provide a slit copper material having high electrical conductivity and excellent bending workability, and a component for electronic/electrical devices, a bus bar, and a heat dissipation substrate, which are formed of this slit copper material.

### BRIEF DESCRIPTION OF THE DRAWING

The drawing is a flow chart showing a method of producing a slit copper material according to the present embodiment.

### DETAILED DESCRIPTION OF THE INVENTION

Hereinafter, a slit copper material according to an embodiment of the present invention will be described.

The slit copper material of the present embodiment is a material obtained by slitting a copper plate strip material such that the slit copper material has a predetermined width. In the slit copper material according to the present embodiment, the ratio W/t of the plate width W to the plate thickness t is set to 10 or greater.

The purity of Cu in the slit copper material according to the present embodiment is set to 99.96% by mass or greater. Therefore, it can also be said that the slit copper material contains 99.96% by mass or greater of Cu with the balance of inevitable impurities.

Further, in the slit copper material according to the present embodiment, the electrical conductivity is set to 97.0% IACS or greater.

Further, in the slit copper material according to the present embodiment, the average value of orientation densities at φ2=5°, in a range of φ1=0° to 90°, and at Φ=0° in the plate center portion is set to 2.0 or greater and less than 30.0.

Further, in the slit copper material according to the present embodiment, it is preferable that the average crystal grain size A in the plate center portion is set to 50 μm or less.

Further, in the slit copper material according to the present embodiment, it is preferable that the ratio B/A of the average crystal grain size B in the plate surface layer portion to the average crystal grain size A in the plate center portion is set to be in a range of 0.80 or greater and 1.20 or less.

Further, in the present embodiment, the plate center portion is defined as a region of 25% to 75% of the total thickness from the surface in the plate thickness direction.

Further, the plate surface layer portion is defined as a region of 0% to 20% of the total thickness from the surface in the plate thickness direction.

Further, in the slit copper material according to the present embodiment, it is preferable that the 0.2% proof stress in a direction parallel to the rolling direction is less than 150 MPa.

Further, in the slit copper material according to the present embodiment, it is preferable that an average value of orientation densities at φ2=40°, in a range of φ1=0° to 15°, and in a range of Φ=0° to 15° in the plate center portion is less than 10.0.

In the slit copper material according to the present embodiment, the reasons for specifying the component composition, the texture, and various characteristics as described above will be described below.

(Cu)

In a case where the amount of Cu is high and the concentration of the impurities is relatively small, the electrical conductivity increases. Therefore, in the present embodiment, the amount of Cu is set to 99.96% by mass or greater.

Further, in the slit copper material according to the present embodiment, the amount of Cu is set to preferably 99.97% by mass or greater, more preferably 99.98% by mass or greater, and still more preferably 99.99% by mass or greater in order to further improve the electrical conductivity. The upper limit of the amount of Cu is not particularly limited, but is set to less than 99.9995% by mass because the production cost increases.

(Other inevitable impurities) Examples of other inevitable impurities other than the above-described elements include Al, Ag, As, B, Ba, Be, Bi, Ca, Cd, Cr, Sc, rare earth elements, V, Nb, Ta, Mg, Mo, Ni, W, Mn, Re, Ru, Sr, Ti, Os, P, Co, Rh, Ir, Pb, Pd, Pt, Au, Zn, Zr, Hf, Hg, Ga, In, Ge, Y, Tl, N, S, Sb, Se, Si, Sn, Te, and Li. The slit copper material may contain inevitable impurities within a range not affecting the characteristics.

Since there is a concern that the electrical conductivity is decreased, it is preferable that the amounts of the inevitable impurities are reduced.

(Average value of orientation densities at φ2=5°, in a range of φ1=0° to 90°, and at Φ=0°)

The Euler angle represents the crystal orientation based on the relationship between the specimen coordinate system and the crystal axes of individual crystal grains, and the crystal orientation is expressed by rotating (φ1, Φ, φ2) around the (Z-X-Z) axis from a state where crystal axes (X-Y-Z) match each other. The distribution of the crystal orientation density in a measurement range can be confirmed by displaying the crystal orientation distribution function (ODF) in a three-dimensional Eulerian space using a series expansion method. The orientation density distribution defines a completely random orientation state obtained from a standard powder specimen or the like as 1, and for example, in a case where the orientation density in a certain orientation is 2, this means that the orientation density in this orientation is two times more present than random orientation.

The texture at φ2=5°, in a range of φ1=0° to 90°, and at Φ=0° expressed in terms of Euler angles (φ1, Φ, φ2) in the plate center portion is a recrystallized texture formed by combining a specific heat treatment and rolling working, and satisfactory bending workability can be obtained in a case where the average value of the orientation densities of this texture is 2.0 or greater, which is high. Meanwhile, in a case where the average value of the orientation densities at φ2=5°, in a range of φ1=0° to 90°, and at Φ=0° is extremely high, the possibility that crystal grains having the same crystal orientation are adjacent to each other increases, and the number of high-angle grain boundaries inevitably decreases. That is, the bending workability may be deteriorated due to coarsening of crystal grains.

Therefore, in the present embodiment, when a crystal orientation distribution function obtained from texture analysis by the EBSD method in the plate center portion is expressed in terms of an Euler angle, the average value of orientation densities at Φ2=5°, in a range of Φ1=0° to 90°, and at Φ=0° is 2.0 or greater and less than 30.0.

Further, the lower limit of the average value of the orientation densities at Φ2=5°, in a range of Φ1=0° to 90°, and at Φ=0° is preferably 2.5 or greater, more preferably 3.0 or greater, and still more preferably 3.5 or greater. In addition, the upper limit of the average value of the orientation densities at Φ2=5°, in a range of Φ1=0° to 90°, and at Φ=0° is preferably less than 20.0.

(Average value of orientation densities at Φ2=40°, in a range of Φ1=0° to 15°, and in a range of Φ=0° to 15°)

The texture at Φ2=40°, in a range of Φ1=0° to 15°, and in a range of Φ=0° to 15° in the plate center portion is a rolled texture formed by rolling working, and the bending workability is deteriorated.

Therefore, in the present embodiment, when a crystal orientation distribution function obtained from texture analysis by the EBSD method in the plate center portion is expressed in terms of an Euler angle, it is preferable that the average value of orientation densities at Φ2=40°, in a range of Φ1=0° to 15°, and in a range of Φ=0° to 15° is set to less than 10.0.

The average value of orientation densities at Φ2=40°, in a range of Φ1=0° to 15°, and in a range of Φ=0° to 15° is set to more preferably less than 5.0 and still more preferably less than 3.0. The lower limit of the average value of orientation densities at Φ2=40°, in a range of Φ1=0° to 15°, and in a range of Φ=0° to 15° is not particularly limited, but is preferably greater than 0.1.

(Electrical conductivity: 97.0% IACS or greater)

In the copper alloy according to the present embodiment, the electrical conductivity is 97.0% IACS or greater. The heat generation in a case of electrical conduction is prevented by setting the electrical conductivity to 97.0% IACS or greater so that the slit copper material can be satisfactorily used as a component for electronic/electrical devices such as a terminal, a bus bar, or a heat dissipation substrate as a substitute for a pure copper material.

Further, the electrical conductivity is preferably 97.5% IACS or greater, more preferably 98.0% IACS or greater, still more preferably 98.5% IACS or greater, and even still more preferably 99.0% IACS or greater. The upper limit value of the electrical conductivity is not particularly limited, but is preferably 103.0% IACS or less.

(Average crystal grain size A in plate center portion)

In the slit copper material according to the present embodiment, in a case where the average crystal grain size A in the plate center portion (region of 25% to 75% of the total thickness from the surface in the plate thickness direction) is fine, excellent bending workability is obtained. Further, since the formation of burrs in a case of slitting can be suppressed, and the occurrence of cracking originating from burrs in a case of bending can be suppressed.

Therefore, in the present embodiment, it is preferable that the average crystal grain size A in the plate center portion is set to 50 μm or less.

In order to obtain more excellent bending workability in the slit copper material of the present embodiment, the average crystal grain size A in the plate center portion is set to preferably 40 μm or less and more preferably 30 μm or less. Further, the lower limit of the average crystal grain size A in the plate center portion is not particularly limited, but is substantially 1 μm or greater.

(Ratio B/A of average crystal grain size B in plate surface layer portion to average crystal grain size A in plate center portion)

In the slit copper material according to the present embodiment, in a case where the crystal grain size is non-uniform, the stress is concentrated on grain boundaries of coarse grains during working, localized deformation occurs, and thus occurrence of cracking is accelerated.

Therefore, in the present embodiment, it is preferable that the ratio B/A of the average crystal grain size B in the plate surface layer portion (region of 0% to 20% of the total thickness from the surface in the plate thickness direction) to the average crystal grain size A in the plate center portion (region of 25% to 75% of the total thickness from the surface in the plate thickness direction) is set to be in a range of 0.80 or greater and 1.20 or less.

In the slit copper material of the present embodiment, the lower limit of the ratio B/A of the average crystal grain size B in the plate surface layer portion to the average crystal grain size A in the plate center portion is preferably 0.82 or greater and more preferably 0.85 or greater. Further, the upper limit of the ratio B/A of the average crystal grain size B in the plate surface layer portion to the average crystal grain size A in the plate center portion is preferably 1.18 or less and more preferably 1.15 or less.

Further, the average crystal grain size A in the plate center portion and the average crystal grain size B in the plate surface layer portion are measured by the same method as described in examples described below.

(0.2% proof stress in direction parallel to rolling direction: less than 150 MPa)

In the slit copper material according to the present embodiment, in a case where the 0.2% proof stress in a direction parallel to the rolling direction is less than 150 MPa, occurrence of cracking during the bending can be suppressed.

The 0.2% proof stress in a direction parallel to the rolling direction is more preferably less than 140 MPa and still more preferably less than 130 MPa.

In addition, the lower limit of the 0.2% proof stress is preferably 70 MPa or greater.

Next, a method of producing the slit copper material according to the present embodiment with such a configuration will be described with reference to the flow chart shown in the drawing.

(Melting and Casting Step S01)

First, a copper raw material is melted to obtain molten copper. As the copper raw material, so-called 4N Cu having a purity of 99.99% by mass or greater or so-called 5N Cu having a purity of 99.999% by mass or greater is preferably used.

In order to reduce the hydrogen concentration in a case of melting, it is preferable that the melting is carried out in an atmosphere using an inert gas atmosphere (for example, Ar gas) in which the vapor pressure of H₂O is low and the holding time for the melting is set to the minimum.

Further, the obtained molten copper is poured into a mold to produce an ingot.

In consideration of mass production, it is preferable to use a continuous casting method or a semi-continuous casting method.

(Homogenizing/Solutionizing Step S02)

Next, a heat treatment is performed for homogenization and solutionization of the obtained ingot. An intermetallic compound or the like generated by segregation and concentration of impurities in the solidification process is present inside the ingot in some cases. Therefore, in order to eliminate or reduce the segregated elements and the intermetallic compound, a heat treatment of heating the ingot to 300° C. or higher and 1080° C. or lower is performed. In this manner, impurities are uniformly diffused in the ingot. In addition, it is preferable that the homogenizing/solutionizing step S02 is performed in a non-oxidizing or reducing atmosphere.

In a case where the heating temperature is lower than 300° C., the solutionization may be incomplete, and a large amount of the intermetallic compound may remain in the matrix. On the contrary, in a case where the heating temperature is higher than 1080° C., a part of the copper material serves a liquid phase, and thus the texture and the surface state may be uneven. Therefore, the heating temperature is set to be in a range of 300° C. or higher and 1080° C. or lower.

Further, hot rolling may be performed after the above-described homogenizing/solutionizing step S02 in order to improve the efficiency of rough rolling and homogenize the texture described below. Further, it is preferable that the hot working temperature is set to be in a range of 300° C. or higher and 1080° C. or lower.

(Rough Rolling Step S03)

In order to work in a predetermined shape, rough working is performed. Further, the temperature conditions for this rough rolling step S03 are not particularly limited, but the working temperature is set to be preferably in a range of −200° C. to 200° C., in which cold rolling or warm rolling is carried out, and particularly preferably room temperature for the purpose of suppressing recrystallization or improving the dimensional accuracy. Uniformly recrystallized grains can be obtained in an intermediate heat treatment step S04 described below by uniformly introducing a strain into the material.

Further, in order to set the average value of the orientation densities at φ2=5°, in a range of φ1=0° to 90°, and at Φ=0° formed by recrystallization in the intermediate heat treatment step S04 to 2.0 or greater and less than 30.0, the total working rate is preferably 85% or greater, more preferably 90% or greater, and still more preferably 95% or greater.

Further, for the purpose of setting the ratio B/A of the average crystal grain size B in the plate surface layer portion to the average crystal grain size A in the plate center portion to be closer to 1 or improving the productivity, the working rate per pass is preferably 20% or greater, more preferably 30% or greater, and still more preferably 40% or greater.

(Intermediate Heat Treatment Step S04)

After the rough rolling step S03, a heat treatment is performed to obtain a recrystallized texture. Further, the rough rolling step S03 and the intermediate heat treatment step S04 may be repeatedly performed.

Since this intermediate heat treatment step S04 is substantially the final recrystallization heat treatment, the crystal grain size of the recrystallized texture obtained in this step is approximately the same as the final crystal grain size. Therefore, in the intermediate heat treatment step S04, it is preferable that the heat treatment conditions are appropriately selected such that the average crystal grain size in the plate center portion is set to 50 μm or less.

Further, in order to set the average value of the orientation densities at φ2=5°, in a range of φ1=0° to 90°, and at Φ=0° to be 2.0 or greater and less than 30.0, which are formed by recrystallization, it is preferable that the temperature increase rate in the intermediate heat treatment step S04 is set to 1° C./sec or greater and 50° C./sec or less, the reaching temperature in the step is set to 200° C. or higher and 700° C. or lower, the holding time in the step is set to 10 sec or longer and 500 sec or shorter, and the temperature decrease rate in the step is set to 1° C./sec or greater and 50° C./sec or less.

(Finish Rolling Step S05)

Finish rolling is performed to work the copper material after the intermediate heat treatment step S04 in a predetermined shape. Further, the finish rolling step S05 is performed under a temperature condition of preferably −200° C. to 200° C., at which cold working or warm working is performed, and particularly preferably room temperature for the purpose of suppressing recrystallization during rolling.

Further, the rolling rate is appropriately selected such that the shape of the slit copper material is close to the final shape, but the orientation densities at φ2=5°, in a range of φ1=0° to 90°, and at Φ=0° formed by recrystallization in the intermediate heat treatment step S04 are decreased in a case where the rolling rate in this step is extremely high. Further, the orientation densities at φ2=40°, in a range of φ1=0° to 15°, and in a range of Φ=0° to 15° in the rolled texture is also excessively increased. Therefore, the rolling rate is set to preferably 60% or less and more preferably 50% or less.

(Mechanical Surface Treatment Step S06)

A mechanical surface treatment is performed after the finish rolling step S05. The mechanical surface treatment is a treatment of applying a compressive stress to the vicinity of the surface after a desired shape is almost obtained, and has an effect of suppressing the occurrence of cracking during the bending by the compressive stress in the vicinity of the surface and improving the bending workability.

As the mechanical surface treatment, various methods typically used, such as a shot peening treatment, a blast treatment, a lapping treatment, a polishing treatment, buff polishing, grinder polishing, sandpaper polishing, a tension leveler treatment, and light rolling with a low rolling reduction ratio per pass (light rolling is repeatedly performed three times or more by setting the rolling reduction ratio per pass to 1% to 10%) can be used.

(Finish Heat Treatment Step S07)

Next, the copper material obtained by the mechanical surface treatment step S06 may be subjected to a finish heat treatment in order to remove the residual strain.

Since the texture formed by the intermediate heat treatment step S04 or the crystal grain size changes due to recrystallization in a case where the heat treatment temperature is extremely high, it is preferable that the heat treatment temperature is set to be in a range of 100° C. or higher and 800° C. or lower. For example, it is preferable to hold at 200° C. for approximately 0.1 to 100 seconds and preferable to hold at 100° C. for 1 minute to 100 hours. It is preferable that the heat treatment is performed in a non-oxidizing atmosphere or a reducing atmosphere. A method of performing the heat treatment is not particularly limited, but it is preferable that the heat treatment is performed using a continuous annealing furnace for a short period of time from the viewpoint of the effect of reducing the production cost.

Further, the finish rolling step S05, the mechanical surface treatment step S06, and the finish heat treatment step S07 may be repeatedly performed.

In addition, metal plating (such as Sn plating, Ni plating, or Ag plating) may be carried out after the finish heat treatment step S07.

(Slitting Step S08)

The copper material obtained by the finish heat treatment step S07 is subjected to slitting to work the copper material in a desired shape. The slitting is performed by shear working with a slit cutter, but burrs formed in the copper material during the slitting act as a starting point of the stress concentration during working such as the subsequent edgewise bending and thus greatly degrade the workability. In a case where the clearance during the slitting is increased, burrs tend to increase. However, in a case where the clearance during the slitting is excessively small, the entire cut surface of the slit is a sheared surface and no fracture surface is formed, and thus large burrs called plastic burrs are formed. Therefore, the clearance during the slitting is required to have an appropriate value, and the ratio of the clearance to the plate thickness (clearance/plate thickness) is set to preferably 0.5% or greater and 12% or less, more preferably 1% or greater and 10% or less, and most preferably 2% or greater and 8% or less.

Further, after the slitting, deburring may be performed to remove the burrs formed in the slitting. Various commonly used methods such as sandpaper, an abrasive sheet, a rotary bar, an abrasive disc, an abrasive belt, and a blast treatment can be used for deburring.

Further, the slitting may be performed by a precision shearing method to obtain a cut surface without burrs. Specifically, various commonly used methods such as a counter cut method of separating materials by semi-shearing and reverse shearing and a roll slitting method of separating materials by semi-shearing and pressing with a roll.

In this manner, the slit copper material according to the present embodiment is produced.

In a case where the plate thickness of the slit copper material is set to 0.1 mm or greater, the slit copper material is suitable to be used as a conductor for high-current applications. Further, in a case where the plate thickness of the slit copper material is set to 10.0 mm or less, an increase in the load of a press machine can be suppressed, the productivity per unit time can be ensured, and thus the production cost can be reduced.

Therefore, it is preferable that the plate thickness of the slit copper material is set to be in a range of 0.1 mm or greater and 10.0 mm or less.

Further, the lower limit of the plate thickness of the slit copper material is set to preferably 0.5 mm or greater and more preferably 1.0 mm or greater. In addition, the upper limit of the plate thickness of the slit copper material is set to preferably less than 9.0 mm and more preferably less than 8.0 mm.

In the slit copper material according to the present embodiment with the above-described configuration, since the purity of Cu is set to 99.96% by mass or greater, the electrical conductivity can be ensured, and the electrical conductivity can be set to 97.0% IACS or greater.

In addition, since the average value of orientation densities at φ2=5°, in a range of φ1=0° to 90°, and at Φ=0° in the plate center portion is set to 2.0 or greater and less than 30.0, the bending workability can be sufficiently improved.

Further, in the slit copper material according to the present embodiment, the bending workability can be further improved in a case where the average crystal grain size A in the plate center portion is set to 50 μm or less. Further, formation of burrs in a case of slitting can be suppressed, and occurrence of cracking originating from burrs in a case of bending can be suppressed.

Further, in the slit copper material according to the present embodiment, in a case where the ratio B/A of the average crystal grain size B in the plate surface layer portion to the average crystal grain size A in the plate center portion is set to be in a range of 0.80 or greater and 1.20 or less, localized concentration of the stress during working can be suppressed, and the bending workability can be further improved.

Moreover, in the slit copper material according to the present embodiment, in a case where the 0.2% proof stress in a direction parallel to the rolling direction is less than 150 MPa, the bending workability can be further improved.

Further, in the slit copper material according to the present embodiment, in a case where the average value of the orientation densities at φ2=40°, in a range of φ1=0° to 15°, and in a range of Φ=0° to 15° in the plate center portion is less than 10.0, the rolled texture is reduced, and the bending workability can be further improved.

Further, in a case where the slit copper material according to the present embodiment has a thickness of 0.1 mm or greater and 10 mm or less, a component for electronic/electrical devices, such as a bus bar or a heat dissipation substrate, can be formed by subjecting the slit copper material to punching or bending.

Further, in a case where a metal plating layer is formed on the surface of the slit copper material according to the present embodiment, the slit copper material is particularly suitable as a material of a component for electronic/electrical devices, such as a bus bar or a heat dissipation substrate.

Since the component for electronic/electrical devices, the bus bar, and the heat dissipation substrate according to the above-described embodiment are produced by using the slit copper material having high proof stress and excellent bending workability as described above, the size and the weight thereof can be reduced.

Hereinbefore, the slit copper material and the component for electronic/electrical devices (such as a bus bar or a heat dissipation substrate) according to the embodiment of the present invention have been described, but the present invention is not limited thereto and can be appropriately changed within a range not departing from the technical features of the invention.

For example, in the above-described embodiment, the example of the method of producing the slit copper material has been described, but the method of producing the copper alloy is not limited to the description of the embodiment, and the slit copper material may be produced by appropriately selecting a production method of the related art.

### EXAMPLES

Hereinafter, results of a verification test conducted to verify the effects of the present invention will be described.

A raw material consisting of so-called 3N Cu having a purity of 99.9% by mass or greater or a raw material consisting of so-called 5N Cu having a purity of 99.999% by mass or greater, which had been obtained by a zone melting refining method, was put into a high-purity graphite crucible and subjected to high-frequency induction melting in an atmosphere furnace having an Ar gas atmosphere.

Further, an ingot having the component composition listed in Tables 1 and 2 was produced by pouring the obtained molten copper into a heat insulating material (refractory material) mold. Further, the size of the ingot was set such that the thickness was approximately 70 mm, the width was approximately 500 mm, and the length was approximately in a range of 150 to 200 mm.

The obtained ingot was heated at 900° C. for 1 hour in an Ar gas atmosphere, and the surface was ground to remove the oxide film, and the ingot was cut into a predetermined size.

Thereafter, the thickness of the ingot was appropriately adjusted to obtain the final thickness, and the ingot was cut. Each of the cut specimens was subjected to rough rolling under the conditions listed in Tables 1 and 2. Next, an intermediate heat treatment was performed under the conditions listed in Tables 1 and 2.

Next, finish rolling (finish working step) was performed under the conditions listed in Tables 1 and 2.

Next, these specimens were subjected to a mechanical surface treatment step by the method listed in Tables 1 and 2.

Further, the buff polishing was performed using #1000 abrasive paper.

Further, sandpaper polishing was performed using #400 abrasive paper.

The grinder polishing was performed using a #400 bearing wheel at a speed of 4500 revolutions per minute.

Thereafter, a finish heat treatment was performed under the conditions listed in Tables 1 and 2. Next, slitting or slitting of a precision shearing method (a counter cut method and a roll slitting method) was performed under the condition that the clearance/plate thickness ratio was in a range of 2% to 8%, and a slit copper material was produced such that the plate thicknesses t and the ratio W/t of the plate width W to the plate thickness t were as listed in Tables 1 and 2.

The obtained strip materials were evaluated for the following items.

(Composition Analysis)

Measurement specimens were collected from the obtained ingot, and the copper component was measured by copper electrogravimetry (JIS H 1051). Further, the measurement was performed at two sites, the center portion of the specimen and the end portion of the specimen in the width direction, and the larger amount of copper was defined as the amount of copper of the sample. As a result, it was confirmed that the component compositions were as listed in Tables 1 and 2.

(Average Crystal Grain Size)

A sample with a width of 20 mm and a length of 20 mm was cut out from the obtained strip material for characteristic evaluation, and a surface perpendicular to the width direction of rolling, that is, a transverse direction (TD) surface was used as an observation surface and embedded in a resin to obtain a sample for observation. The average crystal grain size was measured in the following manner using an electron backscatter diffraction patterns (SEM-EBSD) measuring device. The measured crystal grain sizes are listed in Tables 3 and 4.

A surface perpendicular to the width direction of rolling, that is, a transverse direction (TD) surface was used as an observation surface, and the surface was mechanically polished using waterproof abrasive paper and diamond abrasive grains. Next, finish polishing was performed using a colloidal silica solution; and thereby, a sample for measurement was obtained. Thereafter, the observation surface was measured in a measurement area of 10000 μm² or greater at measurement interval of 0.25 μm at an electron beam acceleration voltage of 15 kV by an EBSD method using an EBSD measuring device (Quanta FEG 450, manufactured by FEI, OIM Data Collection, manufactured by EDAX/TSL (currently AMETEK)) and analysis software (OIM Data Analysis ver. 7.3.1, manufactured by EDAX/TSL (currently AMETEK)). The measured results were analyzed by the data analysis software OIM to obtain CI value at each measurement point. The measurement points with a CI value of 0.1 or less were excluded, and the orientation difference between crystal grains was analyzed by the data analysis software OIM. Further, a boundary having 15° or greater of an orientation difference between neighboring measurement points was assigned as a high-angle grain boundary, and a boundary having less than 15° of an orientation difference between neighboring measurement points was assigned as a low-angle grain boundary. The twin crystal boundaries were also assigned as high-angle grain boundaries. Further, the measurement range was adjusted such that each sample contained 100 or more crystal grains. A crystal grain boundary map was created using the high-angle grain boundaries based on the obtained orientation analysis results. Five line segments with a predetermined vertical length and five line segments with a predetermined horizontal length were drawn on the crystal grain boundary map in conformity with the cutting method of JIS H 0501, the number of crystal grains that were completely cut was counted, and the average value was obtained by dividing the total cut length (length of the line segments cut off by the crystal grain boundaries) by the number of crystal grains. The average value was defined as the average crystal grain size.

Next, the average crystal grain size A in the plate center portion (region of 25% to 75% of the total thickness from the surface in the plate thickness direction) and the average crystal grain size B in the plate surface layer portion (region of 0% to 20% of the total thickness from the surface in the plate thickness direction) were calculated.

(Orientation Density)

The observation surface (TD surface) was measured at measurement interval of 1/10 or less of the average crystal grain size A in the plate center portion at an electron beam acceleration voltage of 15 kV by an EBSD measuring device and OIM analysis software using the above-described sample for measurement. The measured results in a total measurement area of 10000 μm² or greater in a plurality of visual fields, ensured such that a total of 1000 or more crystal grains were included in a depth range of 25% to 75% of the total thickness from the surface in the plate thickness direction (the plate center portion), were analyzed by data analysis software OIM, and a confidence index (CI) value of each measurement point was obtained. The measurement points in which the CI value was 0.1 or less were removed, and the texture was analyzed by the data analysis software OIM to obtain the crystal orientation distribution function.

The crystal orientation distribution function obtained by the analysis was expressed in terms of an Euler angle. The average value of the obtained orientation densities at φ2=5°, in a range of φ1=0° to 90°, and at Φ=0° and the average value of the obtained orientation densities at φ2=40°, in a range of φ1=0° to 15°, and in a range of Φ=0° to 15° are listed in Tables 3 and 4.

(Electrical Conductivity)

Test pieces having a width of 10 mm and a length of 60 mm were collected from each strip material for characteristic evaluation and the electric resistance was acquired according to a 4 terminal method. Further, the dimension of each test piece was measured using a micrometer and the volume of the test piece was calculated. In addition, the electrical conductivity was calculated from the measured electric resistance value and volume. Further, the test pieces were collected such that the longitudinal directions thereof were parallel to the rolling direction of each strip material for characteristic evaluation. The evaluation results are listed in Tables 3 and 4.

(Mechanical Properties)

#13B test pieces specified in JIS Z 2241 were collected from each strip material for characteristic evaluation and the 0.2% proof stress was measured according to the offset method in JIS Z 2241. Further, the test pieces were collected in a direction parallel to the rolling direction. The evaluation results are listed in Tables 3 and 4.

(Bending Workability)

Edgewise bending was performed under the condition that the ratio (R/W) of the inner curvature radius (R) to the plate width (W) was set to the value listed in Tables 3 and 4, and the bent portion of the outer peripheral side surface was observed. A case where wrinkles were not found was evaluated as “A” (excellent), a case where wrinkles were found was evaluated as “B” (good), a case where small cracks were found was evaluated as “C” (fair), and a case where the bent portion was fractured and edgewise bending could not be performed was evaluated as “D” (poor). The evaluation results A to C were determined as acceptable bending workability.

TABLE 1

| | | Component | Production step | | | | | |
|---|---|---|---|---|---|---|---|---|
| | | composition | Rough | Intermediate heat treatment | | | | Finish |
| | | (mass | rolling | Temperature | | | Temperature | rolling |
| | | ratio) | Rolling | increasing | Reaching | | decreasing | Rolling |
| | | Cu | rate | rate | temperature | Time | rate | rate |
| | | % | % | ° C./sec. | ° C. | sec. | ° C./sec. | % |
| Invention | 1 | 99.96 | 95 | 20 | 250 | 100 | 20 | 10 |
| Examples | 2 | 99.97 | 96 | 20 | 350 | 100 | 20 | 5 |
| | 3 | 99.98 | 98 | 40 | 550 | 10 | 40 | 5 |
| | 4 | 99.99 | 97 | 20 | 300 | 60 | 20 | 5 |
| | 5 | 99.99 | 98 | 40 | 200 | 10 | 40 | 20 |
| | 6 | 99.99 | 98 | 20 | 210 | 60 | 20 | 10 |
| | 7 | 99.99 | 98 | 40 | 650 | 10 | 40 | 1 |
| Invention | 8 | 99.99 | 98 | 20 | 700 | 60 | 20 | 1 |
| Examples | 9 | 99.99 | 95 | 20 | 800 | 150 | 20 | 5 |
| | 10 | 99.99 | 85 | 1 | 250 | 450 | 1 | 1 |
| | 11 | 99.99 | 91 | 5 | 500 | 250 | 5 | 1 |
| | 12 | 99.99 | 87 | 1 | 450 | 400 | 1 | 5 |
| | 13 | 99.99 | 98 | 40 | 200 | 10 | 40 | 20 |
| | 14 | 99.99 | 98 | 20 | 210 | 60 | 20 | 10 |

| | | | | | | | Ratio |
|---|---|---|---|---|---|---|---|
| | | Production step | | | | | W/t of |
| | | Mechanical | | | | | plate |
| | | surface | | Finish heat | | Plate | width W |
| | | treatment | Slitting | treatment | | thickness | to plate |
| | | Working | Working | Temperature | Time | t | thickness |
| | | method | method | ° C. | sec. | mm | t |
| Invention | 1 | Buff | Conventional | 170 | 500 | 2.0 | 10 |
| Examples | | polishing | slitting | | | | |
| | 2 | Sandpaper | Conventional | 190 | 200 | 2.0 | 20 |
| | | polishing | slitting | | | | |
| | 3 | Grinder | Conventional | 220 | 20 | 0.5 | 100 |
| | | polishing | slitting | | | | |
| | 4 | Buff | Conventional | 200 | 60 | 1.0 | 20 |
| | | polishing | slitting | | | | |
| | 5 | Buff | Conventional | — | — | 0.5 | 40 |
| | | polishing | slitting | | | | |
| | 6 | Sandpaper | Conventional | 130 | 180000 | 1.0 | 20 |
| | | polishing | slitting | | | | |
| | 7 | Grinder | Conventional | 150 | 14400 | 0.2 | 100 |
| | | polishing | slitting | | | | |
| Invention | 8 | Buff | Conventional | 240 | 4 | 1.0 | 20 |
| Examples | | polishing | slitting | | | | |
| | 9 | Buff | Conventional | 200 | 60 | 3.0 | 10 |
| | | polishing | slitting | | | | |
| | 10 | Sandpaper | Conventional | 240 | 4 | 9.0 | 10 |
| | | polishing | slitting | | | | |
| | 11 | Grinder | Conventional | 260 | 1 | 5.0 | 20 |
| | | polishing | slitting | | | | |
| | 12 | Sandpaper | Conventional | 140 | 50000 | 8.0 | 10 |
| | | polishing | slitting | | | | |
| | 13 | Buff | Counter cut | — | — | 0.5 | 40 |
| | | polishing | method | | | | |
| | 14 | Sandpaper | Counter cut | 130 | 180000 | 1.0 | 20 |
| | | polishing | method | | | | |

TABLE 2

| | | Component | Production step | | | | | |
|---|---|---|---|---|---|---|---|---|
| | | composition | Rough | Intermediate heat treatment | | | | Finish |
| | | (mass | rolling | Temperature | | | Temperature | rolling |
| | | ratio) | Rolling | increasing | Reaching | | decreasing | Rolling |
| | | Cu | rate | rate | temperature | Time | rate | rate |
| | | % | % | ° C./sec. | ° C. | sec. | ° C./sec. | % |
| Invention | 15 | 99.99 | 98 | 40 | 650 | 10 | 40 | 1 |
| Examples | 16 | 99.99 | 98 | 20 | 700 | 60 | 20 | 1 |
| | 17 | 99.99 | 94 | 20 | 600 | 200 | 20 | 5 |
| | 18 | 99.99 | 70 | 1 | 800 | 500 | 1 | 1 |
| | 19 | 99.99 | 99 | 40 | 550 | 10 | 40 | 10 |
| | 20 | 99.99 | 97 | 1 | 250 | 350 | 1 | 10 |
| | 21 | 99.99 | 96 | 1 | 300 | 400 | 1 | 10 |
| Examples | 22 | 99.99 | 95 | 5 | 250 | 200 | 5 | 55 |
| Invention | 23 | 99.99 | 97 | 20 | 300 | 60 | 20 | 40 |
| | 24 | 99.99 | 96 | 20 | 250 | 100 | 20 | 30 |
| Examples | 1 | 99.79 | 98 | 20 | 600 | 10 | 20 | 60 |
| Comparative | 2 | 99.99 | 50 | 70 | 600 | 20 | 70 | 70 |
| | 3 | 99.99 | 99 | 1 | 700 | 700 | 1 | 1 |

| | | Production step | | | | | Ratio W/t |
|---|---|---|---|---|---|---|---|
| | | Mechanical | | | | | of plate |
| | | surface | | | | Plate | width W |
| | | treatment | Slitting | Finish heat treatment | | thickness | to plate |
| | | Working | Working | Temperature | Time | t | thickness |
| | | method | method | ° C. | sec. | mm | t |
| Invention | 15 | Grinder | Roll slitting | 150 | 14400 | 0.2 | 100 |
| Examples | | polishing | method | | | | |
| | 16 | Buff | Roll slitting | 240 | 4 | 1.0 | 20 |
| | | polishing | method | | | | |
| | 17 | Sandpaper | Conventional | 190 | 250 | 3.0 | 10 |
| | | polishing | slitting | | | | |
| | 18 | Grinder | Conventional | 200 | 60 | 10.0 | 10 |
| | | polishing | slitting | | | | |
| | 19 | Buff | Conventional | 210 | 40 | 0.1 | 200 |
| | | polishing | slitting | | | | |
| | 20 | Grinder | Conventional | 150 | 15000 | 1.0 | 10 |
| | | polishing | slitting | | | | |
| | 21 | Sandpaper | Conventional | 160 | 5000 | 2.0 | 10 |
| | | polishing | slitting | | | | |
| Examples | 22 | Buff | Conventional | 190 | 200 | 1.5 | 10 |
| Invention | | polishing | slitting | | | | |
| | 23 | Sandpaper | Conventional | 210 | 40 | 1.0 | 20 |
| | | polishing | slitting | | | | |
| | 24 | Grinder | Conventional | 250 | 2 | 1.5 | 20 |
| | | polishing | slitting | | | | |
| Examples | 1 | Buff | Conventional | 250 | 40 | 0.5 | 100 |
| Comparative | | polishing | slitting | | | | |
| | 2 | Buff | Conventional | 190 | 300 | 2.0 | 20 |
| | | polishing | slitting | | | | |
| | 3 | Buff | Conventional | 180 | 500 | 0.5 | 40 |
| | | polishing | slitting | | | | |

TABLE 3

| | | | Average | | | Average | | | | |
|---|---|---|---|---|---|---|---|---|---|---|
| | | Average | crystal | | Average | value of | | | | |
| | | crystal | grain | | value of | orientation | | | | |
| | | grain | size B in | | orientation | densities | | | Ratio R/W | |
| | | size A in | plate | | densities | at φ2 = 40°, | | | of inner | |
| | | plate | surface | | at φ2 = 5°, | in range of | | | curvature | |
| | | center | layer | | in range of | φ1 = 0° to 15°, | GW proof | Electrical | radius R | |
| | | portion | portion | | φ1 = 0° to 90°, | and in range | stress | conductivity | to plate | Bending |
| | | μm | μm | B/A | and at Φ = 0° | of Φ = 0° to 15° | MPa | % IACS | width W | workability |
| Invention | 1 | 26 | 25 | 0.96 | 20 | 3 | 78 | 97.2 | 1.00 | A |
| Examples | 2 | 32 | 31 | 0.97 | 22 | 2 | 73 | 97.6 | 1.00 | A |
| | 3 | 42 | 41 | 0.98 | 23 | 2 | 75 | 98.4 | 1.00 | A |
| | 4 | 29 | 29 | 1.00 | 23 | 2 | 74 | 100.2 | 1.00 | A |
| | 5 | 5 | 5 | 1.00 | 24 | 4 | 149 | 97.5 | 0.75 | B |
| | 6 | 10 | 11 | 1.10 | 25 | 3 | 138 | 97.6 | 0.75 | B |
| | 7 | 48 | 48 | 1.00 | 24 | 1 | 70 | 100.2 | 0.75 | B |
| | 8 | 50 | 48 | 0.96 | 23 | 1 | 71 | 100.8 | 0.75 | B |
| | 9 | 68 | 67 | 0.99 | 18 | 2 | 72 | 100.9 | 0.50 | C |
| | 10 | 26 | 31 | 1.19 | 2 | 1 | 73 | 99.7 | 0.67 | B |
| | 11 | 38 | 44 | 1.16 | 12 | 1 | 73 | 100.2 | 0.75 | B |
| | 12 | 36 | 29 | 0.81 | 4 | 2 | 74 | 100.3 | 0.75 | B |
| | 13 | 6 | 5 | 0.83 | 25 | 3 | 148 | 97.5 | 0.50 | A |
| | 14 | 10 | 12 | 1.20 | 26 | 3 | 137 | 97.7 | 0.40 | A |

TABLE 4

| | | | Average | | | Average | | | | |
|---|---|---|---|---|---|---|---|---|---|---|
| | | Average | crystal | | Average | value of | | | | |
| | | crystal | grain | | value of | orientation | | | | |
| | | grain | size B in | | orientation | densities | | | Ratio R/W | |
| | | size A in | plate | | densities | at φ = 40°, | | | of inner | |
| | | plate | surface | | at φ2 = 5°, | in range of | | | curvature | |
| | | center | layer | | in range of | φ1 = 0° to 15°, | GW proof | Electrical | radius R | |
| | | portion | portion | | φ1 = 0° to 90°, | and in range | stress | conductivity | to plate | Bending |
| | | μm | μm | B/A | and at Φ = 0° | of Φ = 0° to 15° | MPa | % IACS | width W | workability |
| Invention | 15 | 47 | 50 | 1.06 | 23 | 1 | 69 | 100.1 | 0.75 | A |
| Examples | 16 | 49 | 46 | 0.94 | 22 | 1 | 70 | 100.7 | 0.40 | A |
| | 17 | 49 | 41 | 0.84 | 17 | 2 | 75 | 100.8 | 1.00 | A |
| | 18 | 34 | 49 | 1.44 | 2 | 1 | 72 | 100.5 | 0.50 | C |
| | 19 | 42 | 43 | 1.02 | 27 | 3 | 78 | 100.2 | 0.75 | B |
| | 20 | 25 | 27 | 1.08 | 3 | 3 | 77 | 99.6 | 0.70 | B |
| | 21 | 28 | 29 | 1.04 | 3 | 3 | 76 | 99.7 | 0.75 | B |
| | 22 | 21 | 22 | 1.05 | 2 | 9 | 128 | 99.1 | 0.67 | B |
| | 23 | 29 | 31 | 1.07 | 22 | 6 | 121 | 99.5 | 0.75 | B |
| | 24 | 27 | 29 | 1.07 | 21 | 5 | 95 | 99.3 | 0.67 | B |
| Comparative | 1 | 32 | 36 | 1.13 | 3 | 6 | 339 | 83.1 | 0.80 | D |
| Examples | 2 | 24 | 23 | 0.96 | 1 | 15 | 356 | 100.3 | 0.75 | D |
| | 3 | 75 | 76 | 1.01 | 38 | 2 | 65 | 100.3 | 0.75 | D |

In Comparative Example 1, the amount of Cu was 99.79% by mass which was low, and the electrical conductivity was 83.1% IACS which was low. Further, the 0.2% proof stress was 339 MPa, and the bending workability was evaluated as “D” (poor).

In Comparative Example 2, the average value of the orientation densities at φ2=5°, in a range of φ1=0° to 90°, and at Φ=0° was 1, and the bending workability was evaluated as “D” (poor).

In Comparative Example 3, the average value of the orientation densities at φ2=5°, in a range of φ1=0° to 90°, and at Φ=0° was 38, and the bending workability was evaluated as “D” (poor).

On the contrary, in Invention Examples 1 to 24, it was confirmed that the electrical conductivity and the bending workability were excellent.

As shown in the results described above, according to Invention Examples, it was confirmed that a slit copper material having high electrical conductivity and excellent bending workability can be provided.

### INDUSTRIAL APPLICABILITY

The slit copper material of the present embodiment is suitably applied to a component for electronic/electrical devices, a bus bar, and a heat dissipation substrate.

1. A slit copper material, comprising:
Cu in an amount of 99.96% by mass or greater, wherein
a ratio W/t of a plate width W to a plate thickness t is 10 or greater,
an electrical conductivity is 97.0% IACS or greater, and
an average value of orientation densities at φ2=5°, in a range of φ1=0° to 90°, and at Φ=0° in a plate center portion is 2.0 or greater and less than 30.0.

2. The slit copper material according to claim 1,
wherein an average crystal grain size A in the plate center portion is 50 μm or less.

3. The slit copper material according to claim 1,
wherein a ratio B/A of an average crystal grain size B in a plate surface layer portion to the average crystal grain size A in the plate center portion is in a range of 0.80 or greater and 1.20 or less.

4. The slit copper material according to claim 1,
wherein a 0.2% proof stress in a direction parallel to a rolling direction is less than 150 MPa.

5. The slit copper material according to claim 1,
wherein an average value of orientation densities at φ2=40°, in a range of φ1=0° to 15°, and in a range of Φ=0° to 150 in the plate center portion is less than 10.0.

6. The slit copper material according to claim 1,
wherein the slit copper material has a thickness of 0.1 mm or greater and 10 mm or less.

7. The slit copper material according to claim 1, further comprising:
a metal plating layer on a surface.

8. A component for electronic/electrical devices, which is formed of the slit copper material according to claim 1.

9. A bus bar comprising:
the slit copper material according to claim 1.

10. A heat dissipation substrate, which is formed of the slit copper material according to claim 1.
